(19) United States
(12) Patent Application Publication
(10) Pub. No.: US 2004/0115516 A1
(43) Pub. Date: Jun. 17, 2004

(54) Electrode for fuel cell and fuel cell therewith

(75) Inventors: Yasuo Miyake, Ora-gun (JP); Gohei Yoshida, Ikoma-gun (JP); Kazutaka Ikeda, Toyonaka-city (JP)

Correspondence Address: McDERMOTT, WILL & EMERY, 600 13th Street, N.W., Washington, DC, 20005-3096, US

(73) Assignees: SANYO ELECTRIC CO., LTD.; THE HONJO CHEMICAL CORPORATION

(21) Appl. No.: 10/721,350

(22) Filed: Nov. 26, 2003

(30) Foreign Application Priority Data
Nov. 29, 2002 (JP) JP2002-348546

(51) Int. Cl. H01M 4/86; H01M 4/96

(52) U.S. Cl. 429/42; 429/44

(57) ABSTRACT

There are provided a technique for improving a fuel cell output, and a technique for preventing reduction in an output during operation of a fuel cell. An air electrode consists of catalyst particles, carbon particles supporting the catalyst particles, an ion-exchange resin, a catalyst layer comprising a proton-conducting substance and a conductive porous substrate supporting the catalyst layer.

### BACKGROUND OF THE INVENTION

1. Field of the Invention

The present invention relates to a substrate for a fuel cell and a fuel cell comprising the substrate as an electrode.

2. Description of the Related Art

Recently, there has been substantial interest in a fuel cell which shows a higher energy conversion efficiency and generates no harmful materials from a power-generating reaction. A known example of such a fuel cell is a polymer electrolyte fuel cell (PEFC) which can operate at a low temperature of 100 degrees Celsius or lower.

The PEFC has a basic structure in which a solid polymer membrane as an electrolyte membrane is disposed between a fuel electrode and an air electrode, and generates electric power while feeding hydrogen to the fuel electrode and oxygen to the air electrode, according to the following electrochemical reactions.

Fuel electrode: H₂->2H⁺+2e⁻ (1)

Air electrode: ½O₂+2H⁺+2e⁻>H₂O (2)

The fuel and the air electrodes has a structure in which a catalyst layer and a gas-diffusion layer are laminated. The catalyst layers in these electrodes face to each other such that a solid polymer membrane is sandwiched between them, to form the fuel cell. The catalyst layer is a layer to which carbon particles supporting a catalyst are bound via an ion-exchange resin. The gas-diffusion layer acts as a channel for oxygen or hydrogen. The power-generating reaction proceeds in a so-called three-phase interface of the catalyst, the ion-exchange resin and the hydrogen.

In the fuel electrode, the hydrogen contained in a fuel fed is decomposed into hydrogen ions and electrons as shown in equation (1). The hydrogen ions move toward the oxygen electrode through the solid polymer electrolyte membrane while the electrons move to the air electrode via an external circuit. On the other hand, in the air electrode, the oxygen contained in an oxidizing agent fed to the oxygen electrode reacts with the hydrogen ions and the electrons from the fuel electrode to form water as shown in equation (2). Thus, in the external circuit, electrons move from the fuel electrode to the air electrode so that electric power can be taken.

For such a PEFC, it has been proposed that plenty of three-phase interfaces are ensured with a relatively simple configuration (Japanese Laid-open Patent Publication No. 2000-324387: Patent Reference 1). By the way, deficiency of water in the electrode during operation may locally cause a dry region. Particularly in the air electrode, formation of the dry region may be enhanced by heat generation by the reaction in equation (2). In this case, since the ion-exchange resin is conductive for hydrogen ions in a wet state, it cannot conduct protons in the dry region, leading to deteriorated fuel cell properties.

Patent reference 1: Japanese Laid-open Patent Publication No. 2002-134120

### SUMMARY OF THE INVENTION

In view of the above circumstances, an objective of the present invention is to provide a technique for improving a fuel cell output. Another objective of the present invention is to provide a technique for preventing output reduction during operating a fuel cell.

An aspect of the present invention relates to an electrode for a fuel cell. This electrode for a fuel cell comprises a catalyst layer including a proton-conducting substance.

This electrode comprises a catalyst layer including a proton-conducting substance so that during operation of a fuel cell, good proton conductivity can be stably obtained even when a catalyst electrode becomes water deficient. Therefore, a fuel cell output can be increased in comparison with a conventional fuel cell. Furthermore, it can inhibit reduction of a fuel cell output over time.

The term “proton-conducting substance” as used herein refers to a substance having a proton-dissociating functional group, which is introduced separately from an ion-exchange resin for binding carbon particles supporting a catalyst.

Another aspect of the present invention relates to an electrode for a fuel cell. The electrode for a fuel cell comprises a catalyst particle, a carrier supporting the catalyst particle, a catalyst layer including an ion-exchange resin and a conductive porous substrate supporting the catalyst layer, wherein the catalyst layer includes a proton-conducting substance.

In the electrode for a fuel cell, the catalyst layer comprises the ion-exchange resin and another proton-conducting substance. Unlike an ion-exchange resin, the proton-conducting substance can maintain a higher proton conductivity even when the catalyst electrode is in a water-deficient state. It can, therefore, inhibit reduction in an output during operation and stably provide a higher output.

Another aspect of the present invention relates to a fuel cell. The fuel cell comprises an electrode for a fuel cell in a fuel-feeding side, an electrode for a fuel cell in an oxygen-feeding side and a solid electrolyte membrane sandwiched between these electrodes, wherein at least the electrode for a fuel cell in the oxygen-feeding side is any of the electrodes for a fuel cell described above.

In this fuel cell, at least a catalyst layer in the electrode for a fuel cell in the oxygen-feeding side comprises a proton-conducting substance. Thus, even when a water-deficient region is locally formed in the electrode in the oxygen-feeding side during operation of the fuel cell, good proton conductivity can be stably provided. A fuel cell output can be, therefore, increased in comparison with a conventional fuel cell. Furthermore, it can inhibit reduction of a fuel cell output over time.

Moreover, this summary of the invention does not necessarily describe all necessary features so that the invention may also be sub-combination of these described features.

### BRIEF DESCRIPTION OF THE DRAWINGS

FIG. 1 schematically shows a cross-sectional structure of a fuel cell according to an embodiment of the present invention.

FIG. 2 schematically shows a cross-sectional structure of a cell.

FIG. 3 is a schematic enlarged view of a part of a catalyst layer in an air electrode.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

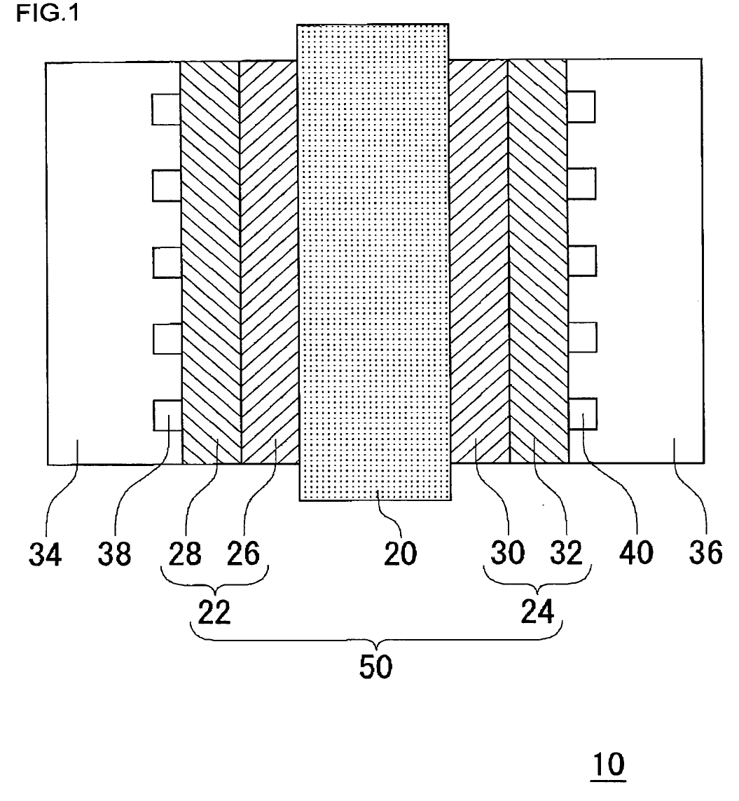

FIG. 1 schematically shows a cross-sectional structure of a fuel cell 10 according to an embodiment of the present invention. The fuel cell 10 comprises a flat cell 50, in both side of which separators 34, 36 are disposed. Although a single cell 50 is shown in this example, the fuel cell 10 may have a configuration in which a plurality of cells 50 are laminated via the separators 34, 36. The cell 50 comprises a solid polymer electrolyte membrane 20, a fuel electrode 22 and an air electrode 24. The fuel electrode 22 and the air electrode 24 can be referred to as “catalyst electrodes”. The fuel electrode 22 comprises a laminate of a catalyst layer 26 and a gas-diffusion layer 28. The air electrode 24 also comprises a laminate of a catalyst layer 30 and a gas-diffusion layer 32. The catalyst layer 26 in the fuel electrode 22 and the catalyst layer 30 in the air electrode 24 are disposed such that they face to each other via the solid polymer electrolyte membrane 20.

The separator 34 disposed in the side of the fuel electrode 22 has a gas channel 38, through which a fuel gas is fed to the cell 50. The separator 36 in the side of the air electrode 24 also has a gas channel 40, through which oxygen is fed to the cell 50. Specifically, during operation of the fuel cell 10, a fuel gas such as hydrogen gas is fed to the fuel electrode 22 via a gas channel 38, while an oxidizing agent gas such as air is fed to the air electrode 24 from a gas channel 40. Thus, a power-generating reaction occurs in the cell 50. When hydrogen gas is fed to the catalyst layer 26 through the gas-diffusion layer 28, hydrogen in the gas is converted into protons, which then move toward the air electrode 24 through the solid polymer electrolyte membrane 20. During the process, released electrons move to an external circuit and then into the air electrode 24. On the other hand, when air is fed to the catalyst layer 30 via the gas-diffusion layer 32, oxygen is coupled with protons to form water. As a result, electrons flow from the fuel electrode 22 toward the air electrode 24 in the external circuit so that an electric power can be taken.

Preferably, the solid polymer electrolyte membrane 20 shows good ion conductivity in a wet state and acts as an ion-exchange membrane which transfers protons between the fuel electrode 22 and the air electrode 24. The solid polymer electrolyte membrane 20 is made of a solid polymer material such as fluoropolymers; for example, sulfonic acid type perfluorocarbon polymers, polysulfone resins, and phosphonic or carboxylic perfluorocarbon polymers. An example of a sulfonic acid type perfluorocarbon polymer is Nafion (DuPont) 112. Examples of a non-fluorinated polymer include aromatic polyether ether ketone and polysulfones.

The gas-diffusion layer 28 in the fuel electrode 22 and the gas-diffusion layer 32 in the air electrode 24 also feed hydrogen gas or air to the catalyst layer 26 and catalyst layer 30, and further transfer a charge generated by the power-generating reaction to the external circuit and discharge water or unreacted gases. The gas-diffusion layer 28 and the gas-diffusion layer 32 are preferably made of an electron-conducting porous material; for example, a carbon paper and a carbon cloth. Herein, it is made water-repellent by coating the porous material with a fluoropolymer. Preferable examples of a solid polymer material such as fluoropolymers include PTFE, tetrafluoroethylene-perfluoroalkylvinyl ether copolymer resin (PFA), tetrafluoroethylene-hexafluoropropylene copolymer resin (FEP) and tetrafluoroethylene-ethylene copolymer resin (ETFE).

The catalyst layer 26 in the fuel electrode 22 and the catalyst layer 30 in the air electrode 24 are porous membranes and consist of an ion-exchange resin and carbon particles supporting a catalyst. Examples of a catalyst supported include platinum, ruthenium and rhodium which can be used alone or in combination of two or more. The carbon particles supporting a catalyst may be, for example, Acetylene black, Ketchen black, Furnace black or carbon nanotube.

The ion-exchange resin electrochemically connects the carbon particles supporting the catalyst with the solid polymer electrolyte membrane 20. The resin is required to be proton-permeable in the fuel electrode 22 and to be oxygen-permeable in the air electrode 24. The ion-exchange resin may be made of a polymer material as described for the solid polymer electrolyte membrane 20.

The catalyst layer 30 further comprises, in addition to the ion-exchange resin, a proton-conducting substance. The term “proton-conducting substance” as used herein refers to a substance having a proton-dissociating functional group, which is present in the catalyst layer 30 separately from the ion-exchange resin.

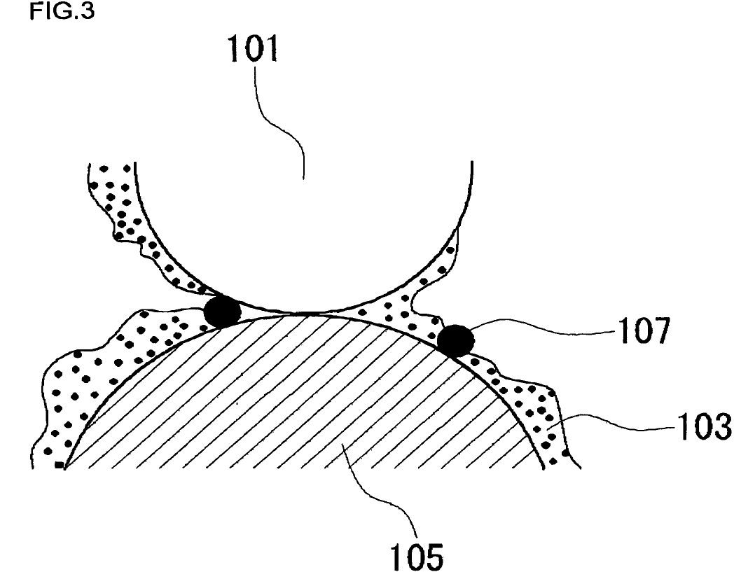

FIG. 3 is a schematic enlarged view of a part of the catalyst layer 30 in the air electrode 24. In this figure, catalyst metals 107 are supported on a catalyst-supporting carbon particle 105, around which ion-exchange resins 103 and proton-conducting substances 101 are dispersed. Thus, the catalyst layer 30 comprises the proton-conducting substance 101 so that even when a dry region is formed in the catalyst layer 30, a proton-conducting channel can be ensured by the proton-conducting substance 101. A three-phase interface can be, therefore, ensured in the catalyst layer 30, resulting in an efficient catalytic reaction.

The proton-conducting substance 101 may be an acid. Examples of a liquid acid which can be used include phosphoric acid, sulfuric acid, acetic acid, oxalic acid, nitric acid and other organic acids. Using a liquid acid, the acid can quickly move to a dry region generated in the catalyst layer 26 for proton conduction, so that a three-phase interface can be reliably formed. When using a liquid acid, an impregnation of the acid is, for example, 0.01 mL/cm² to 0.08 mL/cm² both inclusive. An impregnation of 0.01 mL/cm² or more can ensure good proton conductivity. On the other hand, an impregnation of 0.08 mL/cm² or less can reliably improve electrode performance. An impregnation of the acid is preferably, for example, 0.03 mL/cm² to 0.05 mL/cm² both inclusive.

In the catalyst layer 30, the proton-conducting substance 101 may be a solid acid. A solid acid can be used to prevent the proton-conducting substance from leaking from the catalyst layer 26 to the outside of the electrode. Therefore, safety of the fuel cell 10 can be improved. Examples of a solid acid include heteropolyacids. A heteropolyacid as used herein refers to a condensation acid containing oxygen and two or more elements. It may be one or more selected from a group consisting of phosphomolybdic acid, silicomolybdic acid, phosphotungstic acid, silicotungstic acid, phosphotungstomolybdic acid, silicotungstomolybdic acid, phosphovanadomolybdic acid and phosphovanadotungstic acid. When using a heteropolyacid, an impregnation of the acid is, for example, 0.002 mg/cm² to 0.1 mg/cm² both inclusive. An impregnation of 0.002 mg/cm² or more can ensure good proton conductivity. An impregnation of 0.1 mg/cm² or less can reliably improve electrode performance. An impregnation of the acid is preferably, for example, 0.06 mg/cm² to 0.08 mg/cm² both inclusive.

In the catalyst layer 30, the solid acid may have a water of crystallization or a crystal water. Specific examples of a solid acid having a water of crystallization which can be used include H₃[PMo₁₂O₄₀]·nH₂O, H₄[SiMo₁₂O₄₀]·nH₂O, H₃[PW₁₂O₄₀]·nH₂O, H₄[SiW₁₂O₄₀]·nH₂O, H₃[PWₓMo₁₂₋ₓO₄₀]·nH₂O, H₄[SiWₓMo₁₂₋ₓO₄₀]·nH₂O, H_{z+3[}PV_{z}Mo_{12-z}O₄₀]·nH₂O and H_{z+3}[PV_{z}W_{12-z}O₄₀]·nH₂O, where x and z are integers meeting the conditions of 1≦x≦11 and 1≦z≦4. An example of such a solid acid is a heteropolyacid available from Japan Inorganic Chemical Industry Inc.

In the catalyst layer 30, the proton-conducting substance 101 may be a fullerene derivative. In a fullerene derivative, a number of proton-conducting functional groups originally contained in the molecule are directly involved in proton transfer. Thus, adding such a substance to the catalyst layer 26 as a proton-conducting substance can eliminate the necessity of uptaking hydrogen or protons derived from a water vapor molecule in the atmosphere, and further can achieve good proton conductivity in the catalyst layer 30, independently of the atmospheric conditions such as water supply from the outside and absorption of water from the outside air. Furthermore, since a number of proton-conducting functional groups can be introduced into one molecule of the fullerene derivative, a proton-conducting channel can be suitably ensured in the catalyst layer 30. Furthermore, since the fullerene derivative is conductive, conductivity of the catalyst layer 30 can be also improved. Thus, the fullerene can be used as a proton-conducting substance 101 to further improve electrode properties.

Examples of the fullerene to be a basic structure of the proton-conducting substance 101 include C₃₂, C₆₀, C₇₆, C₇₈, C₈₀, C₈₂ and C₈₄, which can be used alone or in combination of two or more. The fullerene structure may locally have an open end.

A proton-conducting functional group in the fullerene derivative can be represented by —OH or -AOH, where A represents an appropriate atom or atomic group having a divalent ligand; specifically, —OH, —SO₃H, —COOH, —OSO₃H and —OPO(OH)₃. It is preferable that the fullerene has, in addition to the proton-conducting functional group, a functional group including an electron-withdrawing group such as nitro, carbonyl, carboxyl, nitrile and haloalkyl, and halogen such as fluorine and chlorine. Electron-withdrawing effect of the electron-withdrawing group accelerates dissociation of a proton from a proton-conducting functional group and thus, the proton can easily move via the electron-withdrawing group.

Although the fullerene has been described as a carbon material as a backbone for binding a proton-conducting functional group, other carbon materials such as carbon nanotube and carbon nanohorn can be used.

As described above, the fuel cell 10 in this embodiment comprises the catalyst layer 30 comprising the proton-conducting substance 101 so that a proton channel can be formed in the catalyst layer 30, independently of atmospheric moisture. In a conventional fuel cell comprising the catalyst layer 30 comprising the ion-exchange resin 103 alone, a local water-deficient region formed in the catalyst layer 30 may inhibit reliable formation of a proton channel, leading to reduction in an output. However, in the fuel cell 10 according to this embodiment, the proton-conducting substance 101 contributes reliable formation of a proton channel in the catalyst layer 30 even in such a case. In the fuel cell 10, a higher output can be, therefore, stably achieved and output reduction due to long-term use can be minimized.

Although there has been described a combination of the ion-exchange resin 103 and the proton-conducting substance 101 in the fuel cell 10, another embodiment may be employed, where the catalyst layer 30 comprises not an ion-exchange resin but the proton-conducting substance 101 alone. However, when using a solid such as a solid acid and a fullerene derivative as the proton-conducting substance 101, it is preferable to combine the ion-exchange resin 103 and the proton-conducting substance 101 because combination with the ion-exchange resin 103 may improve binding capacity of the catalyst layer 30, resulting in suitable formation of a three-phase interface.

An example of a preparation process for the cell 50 will be described. First, for preparing the fuel electrode 22 and the air electrode 24, a catalyst such as platinum is supported on carbon particles by an appropriate method such as an impregnation method and a colloid method. Next, the carbon particles supporting the catalyst, the ion-exchange resin 103 and the proton-conducting substance 101 are dispersed in a solvent to prepare a catalyst ink. The proton-conducting substance 101 can be selected from those described above.

The catalyst ink is applied to, for example, a carbon paper to be a gas-diffusion layer, and the paper is heated and dried to prepare the fuel electrode 22 and the air electrode 24. Application may be conducted by, for example, brush coating and spraying. Then, the solid polymer electrolyte membrane 20 is sandwiched between the catalyst layer 26 in the fuel electrode 22 and the catalyst layer 30 in the air electrode 24, and they are joined into a laminate by hot pressing, to prepare the cell 50. When the solid polymer electrolyte membrane 20 and the ion-exchange resin 103 in the catalyst layers 26 and 30 are made of a polymer material having a softening point or glass transition point, the hot pressing is preferably conducted at a temperature higher than the softening or glass transition point.

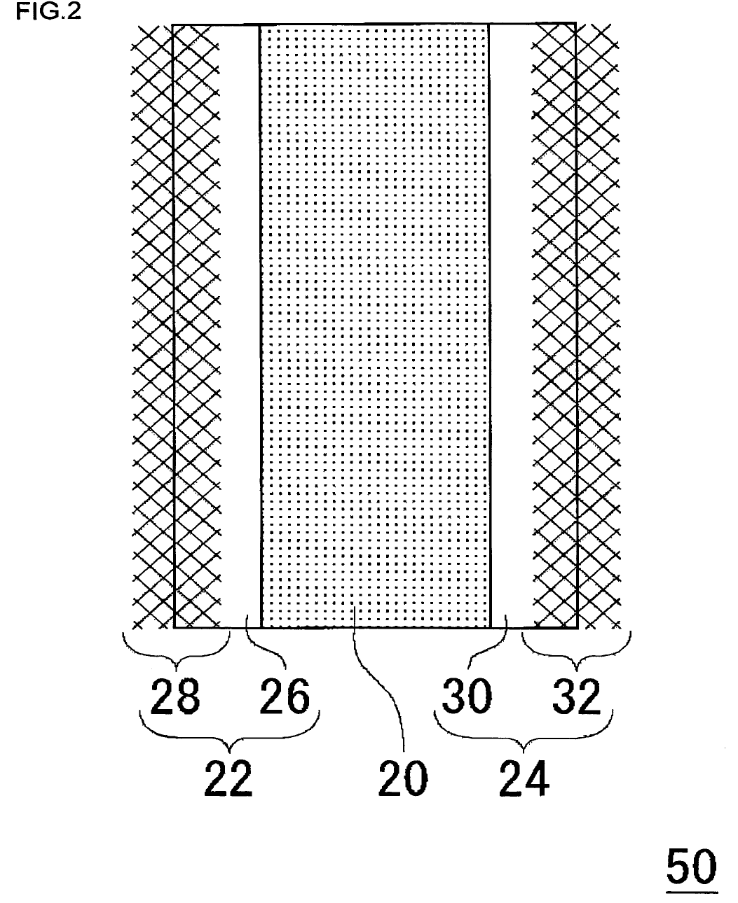

FIG. 2 schematically shows a cross-sectional structure of the cell 50. This figure shows that in the fuel electrode 22, the catalyst layer 26 is inner in relation to the surface of the gas-diffusion layer 28 made of a carbon paper. In the air electrode 24, the catalyst layer 30 is also inner in relation to the gas-diffusion layer 32.

The fullerene derivative used as the proton-conducting substance 101 may be prepare by, for example, a process described in WO0106519. For example, when preparing a polyfullerene hydroxide, fullerene is stirred in a fuming sulfuric acid under a nitrogen atmosphere. Then, a precipitate formed is subjected to several cycles of collection by centrifugation and dispersion in a mixture of diethyl ether and acetone, and then dried to give the desired compound.

### EXAMPLE 1

A porous material, i.e., a carbon paper, was immersed in a dispersion of a fluororesin consisting of a 16 wt % solution of FEP in alcohol, and material was dried at 380 degrees Celsius for one hour and fired to be made water repellent.

To the water-repellent porous material was evenly applied a catalyst slurry by screen printing. The catalyst slurry was a dispersion of carbon powder supporting platinum and H₃PW₁₂O₄₀ in an alcohol solvent. After application, the material was pre-dried and then heated at 200 degrees Celsius to prepare an electrode for a fuel cell. The shape of the electrode was a 5 cm×5 cm square with a thickness of about 200 μm.

Thus, a fuel electrode and an air electrode with an electrode area of 25 cm² and a platinum supporting amount of 0.5 mg/cm². Between the electrodes in the sides of the fuel and the air was sandwiched a Nafion 112 (DuPont, trade name) membrane with a thickness of 50 μm as an electrolyte membrane, and they were joined into a unit cell by hot pressing at 130 degrees Celsius.

### COMPARATIVE EXAMPLE 1

A unit cell was prepared as described in Example 1, except that an electrode for a fuel cell was prepared using a catalyst slurry without H₃PW₁₂O₄₀.

For the fuel cells in Example 1 and Comparative Example 1, a battery voltage and a rate of reduction in a battery voltage were determined after 100 hour operation under the following operation conditions.

Operation Conditions

Fuel: pure hydrogen (80 degrees Celsius, humidified), U_{f} (fuel utilization rate)=70%;

Oxidizing agent: air (74 degrees Celsius, humidified), Uₒₓ (oxidizing-agent utility rate)=40%;

Current density: 0.5 A/cm₂.

TABLE 1

| | | Reduction rate of |
|---|---|---|
| | Battery voltage | a battery voltage |
| | (mV) | (mV/1000 hr) |
| Example 1 | 720 | 1.2 |
| Comparative | 700 | 2.0 |
| Example 1 | | |

Table 1 shows that the fuel cell according to the present invention has an improved battery voltage and less deterioration in fuel cell properties over time than a conventional fuel cell.

Although the present invention has been described by way of exemplary embodiments, it should be understood that many changes and substitutions may further be made by those skilled in the art without departing from the scope of the present invention which is defined by the appended claims.

What is claimed is:

1. An electrode for a fuel cell, comprising a catalyst layer including a proton-conducting substance.

2. An electrode for a fuel cell, comprising:
a catalyst particle;
a carrier supporting the catalyst particle;
a catalyst layer comprising an ion-exchange resin; and
a conductive porous substrate supporting the catalyst layer,
wherein the catalyst layer includes a proton-conducting substance.

3. The electrode for a fuel cell as claimed in claim 1 wherein the proton-conducting substance is an acid.

4. The electrode for a fuel cell as claimed in claim 2 wherein the proton-conducting substance is an acid.

5. The electrode for a fuel cell as claimed in claim 1 wherein the proton-conducting substance is a solid acid.

6. The electrode for a fuel cell as claimed in claim 2 wherein the proton-conducting substance is a solid acid.

7. The electrode for a fuel cell as claimed in claim 3 wherein the proton-conducting substance is a solid acid.

8. The electrode for a fuel cell as claimed in claim 5 wherein the solid acid has a water of crystallization.

9. The electrode for a fuel cell as claimed in claim 6 wherein the solid acid has a water of crystallization.

10. The electrode for a fuel cell as claimed in claim 7 wherein the solid acid has a water of crystallization.

11. The electrode for a fuel cell as claimed in claim 5 wherein the solid acid is a heteropolyacid.

12. The electrode for a fuel cell as claimed in claim 6 wherein the solid acid is a heteropolyacid.

13. The electrode for a fuel cell as claimed in claim 7 wherein the solid acid is a heteropolyacid.

14. The electrode for a fuel cell as claimed in claim 11 wherein the heteropolyacid is one or more selected from a group consisting of phosphomolybdic acid, silicomolybdic acid, phosphotungstic acid, silicotungstic acid, phosphotungstomolybdic acid, silicotungstomolybdic acid, phosphovanadomolybdic acid and phosphovanadotungstic acid.

15. The electrode for a fuel cell as claimed in claim 12 wherein the heteropolyacid is one or more selected from a group consisting of phosphomolybdic acid, silicomolybdic acid, phosphotungstic acid, silicotungstic acid, phosphotungstomolybdic acid, silicotungstomolybdic acid, phosphovanadomolybdic acid and phosphovanadotungstic acid.

16. The electrode for a fuel cell as claimed in claim 13 wherein the heteropolyacid is one or more selected from a group consisting of phosphomolybdic acid, silicomolybdic acid, phosphotungstic acid, silicotungstic acid, phosphotungstomolybdic acid, silicotungstomolybdic acid, phosphovanadomolybdic acid and phosphovanadotungstic acid.

17. The electrode for a fuel cell as claimed in claim 1 wherein the proton-conducting substance is a fullerene derivative.

18. The electrode for a fuel cell as claimed in claim 2 wherein the proton-conducting substance is a fullerene derivative.

19. A fuel cell, comprising:
an electrode for a fuel cell in a fuel-feeding side;
an electrode for a fuel cell in an oxygen-feeding side; and
a solid electrolyte membrane sandwiched between these electrodes,
wherein at least the electrode for a fuel cell in the oxygen-feeding side is the electrode for a fuel cell as claimed in claim 1.

20. A fuel cell, comprising:
an electrode for a fuel cell in a fuel-feeding side;
an electrode for a fuel cell in an oxygen-feeding side; and
a solid electrolyte membrane sandwiched between these electrodes,
wherein at least the electrode for a fuel cell in the oxygen-feeding side is the electrode for a fuel cell as claimed in claim 2.
